(19) United States
(12) Patent Application Publication
(10) Pub. No.: US 2008/0063187 A1
(43) Pub. Date: Mar. 13, 2008

(54) HASH VALUE GENERATION DEVICE, PROGRAM, AND HASH VALUE GENERATION METHOD

(76) Inventors: Hirotaka Yoshida, Yokohama (JP); Dai Watanabe, Kawasaki (JP); Yasuko Fukuzawa, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/740,953

(22) Filed: Apr. 27, 2007

(30) Foreign Application Priority Data
Apr. 27, 2006 (JP) 2006-122868
Apr. 12, 2007 (JP) 2007-104636

(51) Int. Cl. H04L 9/28; H04L 9/06

(52) U.S. Cl. 380/28

(57) ABSTRACT

A hash value generation device has a control part (120) that divides an inputted message into N message blocks of a predetermined data length (N being a natural number), repeats transformation processing a predetermined number R of rounds (R being a natural number larger than or equal to 2) for each of the message blocks, and repeats, N times, block cipher processing in which a value calculated in the transformation processing of R rounds for the n-th message block (n being a natural number) is used as key information for the (n+1)-th message block, to generate a hash value of the inputted message. In shift processing performed in the transformation processing of the control part (120), at least one odd number and at least one even number are included among numbers of bits by which a shift is performed.

### INCORPORATION BY REFERENCE

This application claims a priority from the Japanese Patent Application Nos. 2006-122868 filed on Apr. 27, 2006 and 2007-104636 filed on Apr. 12, 2007, the entire contents of which are incorporated by reference herein.

### BACKGROUND OF THE INVENTION

The present invention relates to a technique of generating a hash value.

Recently, services using highly mobile devices such as portable telephone terminals, non-contact IC cards, commodity tags, and the like, are rapidly becoming widely used.

Usually, this type of service using a highly mobile device employs an authentication technique for identifying a service provider or a person who uses the service.

A Message Authentication Code (MAC) generation method is well known as an authentication technique, and there is a MAC generation method, known as HMAC, which is an MAC generation method based on a cryptographic hash function.

A hash function receives a message of any length as its input, and generates and outputs a hash value. Generally, a hash function is formed by block cipher that receives a message block of a fixed length as input. An inputted message is subjected to block encryption repeatedly so that the message is mixed and finally outputted as a hash value. As representative examples of a hash function, SHA-1, SHA-256, and Whirlpool may be mentioned. (See ISO/IEC 10118-3, third edition, Information technology-Security techniques-Hash functions-, pp. 13-15 and pp. 19-22, published on Mar. 1, 2004, Switzerland).

### SUMMARY OF THE INVENTION

SHA-1, SHA-256 and Whirlpool, known as representative examples of a hash function, have the following problems.

First, it is pointed out that SHA-1 has a problem with theoretical security, referred to as collision resistance.

Next, it is difficult to strictly evaluate security for SHA-256. In particular, a strict security evaluation with respect to a differential attack, which is considered most dangerous among the existing methods of attack, is not known at present.

Furthermore, security for Whirlpool has been evaluated. However, Whirlpool has been designed giving priority to high speed performance, and, as a result, Whirlpool is not suitable for lightweight implementations, such as a device having high mobility, for example, a portable telephone terminal, a non-contact IC card, a commodity tag, or the like.

The present invention provides a hash function that can be implemented at a small scale with theoretical security and implementation security ensured.

In detail, according to the present invention, an inputted message is divided into message block of a predetermined data length, and predetermined transformation is performed repeatedly for each message block. In the repetition of the transformation processing, shift transformation is performed such that a shift operation is performed a plurality of times. At least one shift operation is a shift of an odd number of bits, and at least one shift operation is a shift of an even number of bits.

For example, the present invention provides a hash value generation device having a control part that divides an inputted message into N message blocks of a predetermined data length (N being a natural number), repeats transformation processing a predetermined number R of rounds for each of the message blocks (R being a natural number larger than or equal to 2), and repeats, N times, block cipher processing in which a value calculated in the transformation processing of R rounds for an n-th message block (n being a natural number) is used as key information for an (n+1)-th message block, to generate a hash value of the message, wherein: the transformation processing performed by the control part includes shift transformation; the shift transformation repeats, a predetermined number of times, processing in which one of two pieces of inputted data is subjected to a cyclic shift by a predetermined number of bits, and the shifted piece of data is synthesized with the other piece of data; and among the cyclic shifts that are performed the predetermined number of times, at least one shift is a shift of an odd number of bits, and at least one shift is a shift of an even number of bits.

Thus, the present invention can provide a hash function that realizes small-scale implementation and ensures theoretical security and implementation security.

These and other benefits are described throughout the present specification. A further understanding of the nature and advantages of the invention may be realized by reference to the remaining portions of the specification and the attached drawings.

### BRIEF DESCRIPTION OF THE DRAWINGS

FIG. 1 is a schematic diagram showing an example of a hash value generation device of a first embodiment of the present invention;

FIG. 2 is a schematic diagram showing an example of a key state transformation function fₖ;

FIG. 3 is a diagram showing schematically an example of a plaintext state transformation function f_{R};

FIG. 4 is a schematic diagram showing an example of a nonlinear transformation function F;

FIG. 5 is a schematic diagram explaining an example of block cipher;

FIG. 6 is a schematic diagram showing an example of a computer;

FIG. 7 is a flowchart showing an example of hash value generation processing in the hash value generation device;

FIG. 8 is a schematic diagram showing an example of a hash value generation device of a second embodiment of the present invention;

FIG. 9 is a schematic diagram showing an example of a key transformation function fₖ;

FIG. 10 is a schematic diagram showing an example of a plaintext state transformation function f_{R};

FIG. 11 is a schematic diagram showing a nonlinear transformation function F;

FIG. 12 is a schematic diagram showing an example of a message identifier generation device of a third embodiment;

FIG. 13 is a schematic chart showing an example of a procedure for generating a message identifier; and

FIG. 14 is a diagram showing an example of a delivery system.

### DETAILED DESCRIPTION

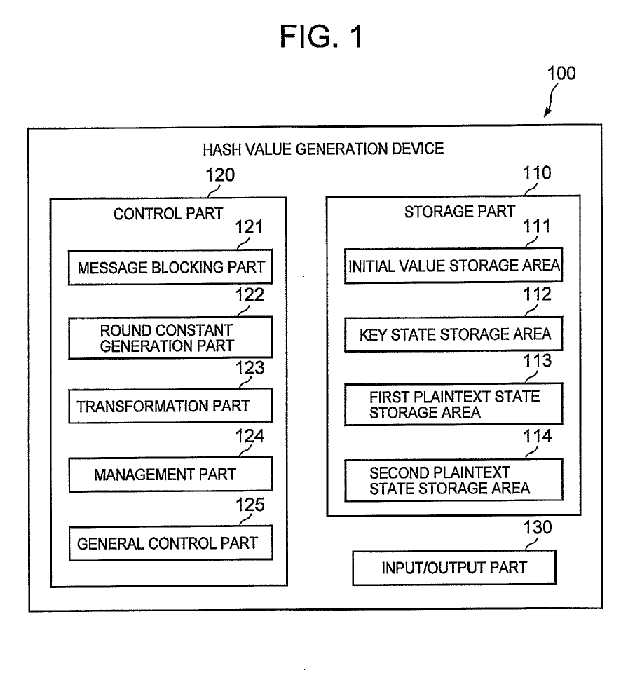

FIG. 1 is a schematic diagram showing a hash value generation device 100 of a first embodiment of the present invention.

As shown in the figure, the hash value generation device 100 comprises a storage part 110, a control part 120, and an input/output part 130.

The storage part 110 comprises an initial value storage area 111, a key state storage area 112, a first plaintext state storage area 113, and a second plaintext state storage area 114.

The initial value storage area 111 stores information specifying initial values in generating a hash value.

In the present embodiment, as the initial values for generating a hash value, an initial value of a round constant and an initial value of a round key are stored.

Here, as the initial value of a round constant, for example, a constant such as c(0)=0xcae1ac3f55054a96 is stored.

Further, as the initial values for a round key, such constants as K₀⁽⁰⁾=0xbc18bf6d, K₁⁽⁰⁾=0x369c955b, K₂⁽⁰⁾=0xbb271cbc, K₃⁽⁰⁾=0xdd66c368, K₄⁽⁰⁾=0x356dba5b, K₅⁽⁰⁾=0x33c00055, K₆⁽⁰⁾=0x50d2320b and K₇⁽⁰⁾=0x1c617e21 are stored.

Constants used as the initial values of the round constant and the round key are not limited to these. For example, it is possible to use random numbers generated by a pseudo-random number generator.

The key state storage area 112 stores information specifying the round key in each round for a message block.

In the present embodiment, a round key in each round for the message block is generated by the below-mentioned transformation part 123, and stored in the key state storage area 112.

The first plaintext state storage area 113 stores information specifying a first plaintext that is calculated for each round.

In the present embodiment, the first plaintext for each round is calculated by the below-mentioned transformation part 123, and stored in the first plaintext state storage area 113.

The second plaintext state storage area 114 stores information specifying a second plaintext that is calculated for each message block.

In the present embodiment, the second plaintext for each message block is calculated by the below-mentioned transformation part 123, and stored in the second plaintext state storage area 114.

The control part 120 comprises a message blocking part 121, a round constant generation part 122, a transformation part 123, a management part 124, and a general control part 125.

The message blocking part 121 performs processing of dividing a message, inputted through the below-mentioned input/output part 130, into message blocks of a predetermined data length.

In the present embodiment, the message blocking part 121 divides a message, inputted through the below-mentioned input/output part 130, into message blocks of 256 bits each.

However, in the case where the length of a message is not a multiple of a message block (256 bits), a padding method such as the Merkle-Damgaard method is employed to pad the message such that the message becomes a multiple of a message block.

The round constant generation part 122 calculates a round constant in each round.

In the present embodiment, a round constant in each round is calculated from an initial value of the round constant stored in the initial value storage area 111.

Further, in the present embodiment, a linear feedback shift register LR, which performs linear transformation of 64 bits, is used as the round constant generation part 122.

Generally, a linear feedback shift register is determined by a definition polynomial. Here, a definition polynomial g(x) that determines LR is defined as follows.

g(x)=x⁶³+x⁶²+x⁵⁸+x⁵⁵+x⁵⁴+x⁵²+x⁵⁰+x⁴⁹+x⁴⁶+x⁴³+x⁴⁰+x³⁸+x³⁷+x³⁵+x³⁴+x³⁰+x²⁸+x²⁶+x²⁴+x²³+x²²+x¹⁸+x¹⁷+x¹²+x¹¹+x¹⁰+x⁷+x³+x²+1

Here, g is a polynomial defined over a finite field GF(2).

When the initial value c(0) is given, the linear feedback shift register LR generates a base value c(r) of the round constant for the r-th round from a base value c(r−1) of the (r−1)-th round constant. Next, as a round constant C(r), the round constant generation part 122 takes the lower block of the base value of the round constant c(r). Details will be described in the following.

First, the round constant generation part 122 inputs the base value c(r−1) of the round constant for the (r−1)-th round into the linear feedback shift register LR to calculate an output value (an output value: y_{H}^{(r)}∥y_{L}^{(r)}=LR(c(r−1)).

Here, y_{L} means left shift of the lower block of the base value c(r−1) by a predetermined number of bits (one bit in the present embodiment), that is, y_{L}^{(r)}=c(r−1)_{L}<<1 (where <<1 expresses a left shift by 1 bit).

Further, y_{H} means left shift of the upper block of the base value c(r−1) by a predetermined number of bits (31 bits in the present embodiment), that is, y_{H}^{(r)}=(c(r−1)_{H}<<1)∥(y_{L}>>31) (where >>31 expresses a right shift by 31 bits).

However, only if the most significant bit of c(r−1) is “1”, then y_{H}^{(r)}=c(r−1)_{H} XOR 0xc4d6496c and y_{L}^{(r)}−c(r−1)_{L} XOR 0x55c61c8d are used.

Next, the round constant generation part 122 calculates the base value c(r) of the round constant for the r-th round by exchanging the upper bits and the lower bits of the output value of LR (c(r)=y_{L}^{(r)}∥y_{H}^{(r)}).

Then, as the round constant C(r), the round constant generation part 122 takes the lower bits of the base value c(r) of the round constant for the next round (C(r)=c(r)_{L}=y_{H}^{(r)}).

In the following, an example of C(r) is shown in the case of R=96.

C(0)=0x51151113; C(1)=0x3b4f5a2f; C(2)=0x2b0e343a; C(3)=0x46b151a6; C(4)=0xac38d0e9; C(5)=0xde130ff4; C(6)=0x1b6f7abf; C(7)=0xbc9a76bc; C(8)=0xc631d3e6; C(9)=0xf269daf1; C(10)=0xdc1106f5; C(11)=0xa6fd1bb3; C(12)=0x1f1e6ba2; C(13)=0x307857d6; C(14)=0x7c79ae88; C(15)=0xc1e15f59; C(16)=0x3530f34d; C(17)=0x68df0d12; C(18)=0x7f4ff42f; C(19)=0x67aa7d25; C(20)=0x9265a0cb; C(21)=0xf1f384e2; C(22)=0xe21aba37; C(23)=0x03185ae5; C(24)=0xe73098aa; C(25)=0xa7ed528f; C(26)=0x58142bc4; C(27)=0x34397327; C(28)=0xa486e67c; C(29)=0x7b69f586; C(30)=0x921b99f1; C(31)=0x29719f74; C(32)=0xe3e25ede; C(33)=0xa5c67dd1; C(34)=0x4b5f3214; C(35)=0x3c95ce5f; C(36)=0xe9aa813c; C(37)=0x59db0067; C(38)=0x627c4d9d; C(39)=0x083671eb; C(40)=0xe6ab4602; C(41)=0x8b55feb7; C(42)=0x5e7b5164; C(43)=0x86dbc3c7; C(44)=0xbd3b0cfc; C(45)=0xb0e33606; C(46)=0xf4ec33f0; C(47)=0xc38cd819; C(48)=0x176686ad; C(49)=0x61691012; C(50)=0xf61623af; C(51)=0x41720925; C(52)=0xb702fecb; C(53)=0x6a9254e2; C(54)=0x7787c237; C(55)=0x6e9f1ae5; C(56)=0xb14578ab; C(57)=0xd5261be2; C(58)=0x6e99dbb7; C(59)=0x904e26e5; C(60)=0xd53d1eaa; C(61)=0xeab4a28f; C(62)=0x902233c5; C(63)=0xc588fa4a; C(64)=0xeb04f60f; C(65)=0xd2f5a045; C(66)=0xc349a84b; C(67)=0x248cf163; C(68)=0x627cd15a; C(69)=0x39bffc97; C(70)=0x4d250c04; C(71)=0x4d73cb47; C(72)=0xf042797d; C(73)=0x5a955d6b; C(74)=0xae539583; C(75)=0x050f05da; C(76)=0x12c26f16; C(77)=0x143c1768; C(78)=0x4b09bc58; C(79)=0x50f05da1; C(80)=0xe8f0b80d; C(81)=0x2c9b06f3; C(82)=0xcc989042; C(83)=0x19e022d7; C(84)=0xf6b40864; C(85)=0xcc0cb247; C(86)=0x1e0668fd; C(87)=0x5f68b96a; C(88)=0xd3959aef; C(89)=0xb974acc5; C(90)=0x210c1bca; C(91)=0x4e5e8a0e; C(92)=0x84306f29; C(93)=0xfdac6154; C(94)=0xbb4d85bf; C(95)=0x3267cc3c.

The transformation part 123 performs transformation of a round key and a first plaintext in each round for a message block. Here, transformation performed by the transformation part does not include arithmetic addition.

First the transformation part 123 of the present embodiment performs transformation of a round key.

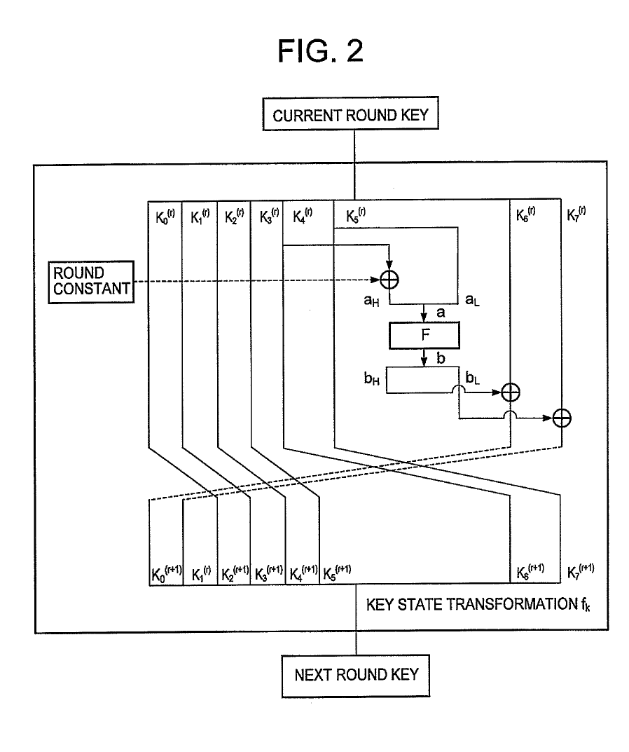

Transformation of a round key is performed, for example, by the key state transformation function fₖ shown in FIG. 2 (a schematic diagram showing the key state transformation function fₖ).

As shown in the figure, the key state transformation fₖ is a function that transforms eight divisions K₀^{(r)}, K₁^{(r)}, K₂^{(r)}, K₃^{(r)}, K₄^{(r)}, K₅^{(r)}, K₆^{(r)} and K₇^{(r)} of a round key of the r-th round into K₀^{(r+1)}, K₁^{(r+1)}, K₂^{(r+1)}, K₃^{(r+1)}, K₄^{(r+1)}, K₅^{(r+1)}, K₆^{(r+1)} and K₇^{(r+1)} respectively, and concatenates the transformed values, to generate a (r+1)-th round key.

In detail, for the key state transformation function fₖ, first the transformation part 123 divides the round key of the r-th round, which is stored in the key state storage area 112, into eight parts K₀^{(r)}, K₁^{(r)}, K₂^{(r)}, K₃^{(r)}, K₄^{(r)}, K₅^{(r)}, K₆^{(r)} and K₇^{(r)} equally.

Next, the transformation part 123 respectively takes K₀^{(r)} and K₁^{(r)} of the round key of the r-th round, as K₂^{(r+1)} and K₃^{(r+1)} of the round key of the (r+1)-th round.

Next, the transformation part 123 calculates the value b_{H} of upper bits of an output value of a nonlinear transformation function F whose inputs are an exclusive-OR of the round constant C(r) and K₄^{(r)}, and the value of K₅^{(r)} (b_{H}=F(k₄ XOR C(r), k₅)_{H}), where C(r) has been generated by the round constant generation part 122, and K₄^{(r)} and K₅^{(r)} have been obtained from the round key of the r-th round.

Next, the transformation part 123 calculates the value b_{L} of lower bits of the output value of the nonlinear transformation function F whose inputs are the exclusive-OR of the round constant C(r) and K₄^{(r)}, and the value of K₅^{(r)} (b_{L}=F(k₄ XOR C(r), k₅)_{L}), where C(r) has been generated by the round constant generation part 122, and K₄^{(r)} and K₅^{(r)} have been obtained from the round key of the r-th round.

Next, the transformation part 123 takes K₂^{(r)} and K₃^{(r)} of the round key of the r-th round as K₄^{(r+1)} and K₅^{(r+1)} of the round key of the (r+1)-th round, respectively.

Next, the transformation part 123 calculates an exclusive-OR of the value b_{H} and K₆^{(r)} of the round key of the r-th round, and takes the calculated value as K₀^{(r+1)} of the round key of the (r+1)-th round.

Next, the transformation part 123 calculates an exclusive-OR of the value b_{L} and K₇^{(r)} of the round key of the r-th round, and takes the calculated value as K₁^{(r+1)} of the round key of the (r+1)-th round.

Next, the transformation part 123 takes K₄^{(r)} and K₅^{(r)} of the round key of the r-th round as K₆^{(r+1)} and K₇^{(r+1)} of the round key of the (r+1)-th round, respectively.

Then, the transformation part 123 concatenates thus-calculated K₀^{(r+1)}, K₁^{(r+1)}, K₂^{(r+1)}, K₃^{(r+1)}, K₄^{(r+1)}, K₅^{(r+1)}, K₆^{(r+1)} and K₇^{(r+1)}, and stores the concatenation result as the round key of the (r+1)-th round into the key state storage area 112, replacing the round key of the r-th round.

Further, the transformation part 123 of the present embodiment transforms a first plaintext.

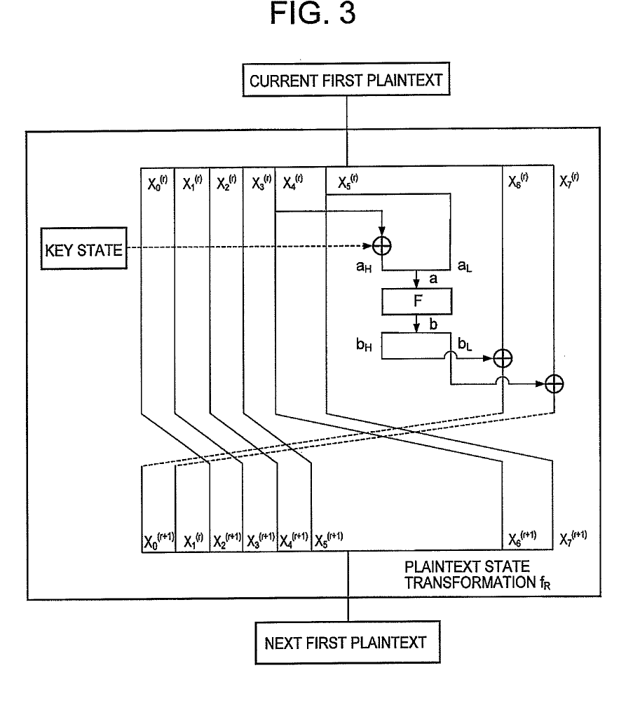

Transformation of a first plaintext is performed, for example, by a plaintext state transformation function f_{R} shown in FIG. 3 (a schematic diagram showing the plaintext state transformation function f_{R}).

As shown in the figure, the plaintext state transformation f_{R} is a function that transforms words X₀^{(r)}, X₁^{(r)}, X₂^{(r)}, X₃^{(r)}, X₄^{(r)}, X₅^{(r)}, X₆^{(r)} and X₇^{(r)}, obtained as eight divisions of a first plaintext of the r-th round, into X₀^{(r+1)}, X₁^{(r+1)}, X₂^{(r+1)}, X₃^{(r+1)}, X₄^{(r+1)}, X₅^{(r+1)}, X₆^{(r+1)} and X₇^{(r+1)} respectively, and then concatenates the values of these transformed words, to generate a first plaintext of the (r+1)-th round.

In detail, as for the plaintext state transformation f_{R}, first the transformation part 123 uses the plaintext state transformation function f_{R} for dividing a first plaintext of the r-th round, which is stored in the first plaintext state storage area 113, into eight words X₀^{(r)}, X₁^{(r)}, X₂^{(r)}, X₃^{(r)}, X₄^{(r)}, X₅^{(r)}, X₆^{(r)} and X₇^{(r)}.

Next, the transformation part 123 takes the words X₀^{(r)} and X₁^{(r)} of the first plaintext of the r-th round as words X₂^{(r+1)} and X₃^{(r+1)} of a first plaintext of the (r+1)-th round, respectively.

Next, the transformation part 123 calculates the value b_{H} of upper bits of an output value of the nonlinear transformation function F whose inputs are an exclusive-OR of the round key K(r) and X₄^{(r)}, and the value of the word X₅^{(r)} (b_{H}=F(X₄ XOR K(r), X₅)_{H}), where K(r) is the round key stored in the key state storage area 112, and X₄^{(r)} and X₅^{(r)} are the words of the first plaintext of the r-th round.

Next, the transformation part 123 calculates the value b_{L} of lower bits of the output value of the nonlinear transformation function F whose inputs are the exclusive-OR of the round key K(r) and X₄^{(r)}, and the value of the word X₅^{(r)} (b_{L}=F (X₄ XOR K(r), X₅)_{L}), where K(r) is the round key stored in the key state storage area 112 and X₄^{(r)} and X₅^{(r)} are the words of the first plaintext of the r-th round.

Next, the transformation part 123 takes the words X₂^{(r)} and X₃^{(r)} of the first plaintext of the r-th round as the words X₄^{(r+1)} and X₅^{(r+1)} of the first plaintext of the (r+1)-th round, respectively.

Next, the transformation part 123 calculates an exclusive-OR of the value b_{H} and the word X₆^{(r)} of the first plaintext of the r-th round, and takes the calculated value as a word X₀^{(r+1)} of the first plain text of the (r+1)-th round.

Next, the transformation part 123 calculates an exclusive-OR of the value b_{L} and the word X₇^{(r)} of the first plaintext of the r-th round, and takes the calculated value as a word X₁^{(r+1)} of the first plaintext of the (r+1)-th round.

Next, the transformation part 123 takes the words X₄^{(r)} and X₅^{(r)} of the first plaintext of the r-th round as words X₆^{(r+1)} and X₇^{(r+1)} of the first plaintext of the (r+1)-th round, respectively.

Then, the transformation part 123 concatenates X₀^{(r+1)}, X₁^{(r+1)}, X₂^{(r+1)}, X₃^{(r+1)}, X₄^{(r+1)}, X₅^{(r+1)}, X₆^{(r+1)} and X₇^{(r+1)}, which are calculated as above, and stores the concatenation result as the first plaintext of the (r+1)-th round into the first plaintext state storage area 113, replacing the first plaintext of the r-th round.

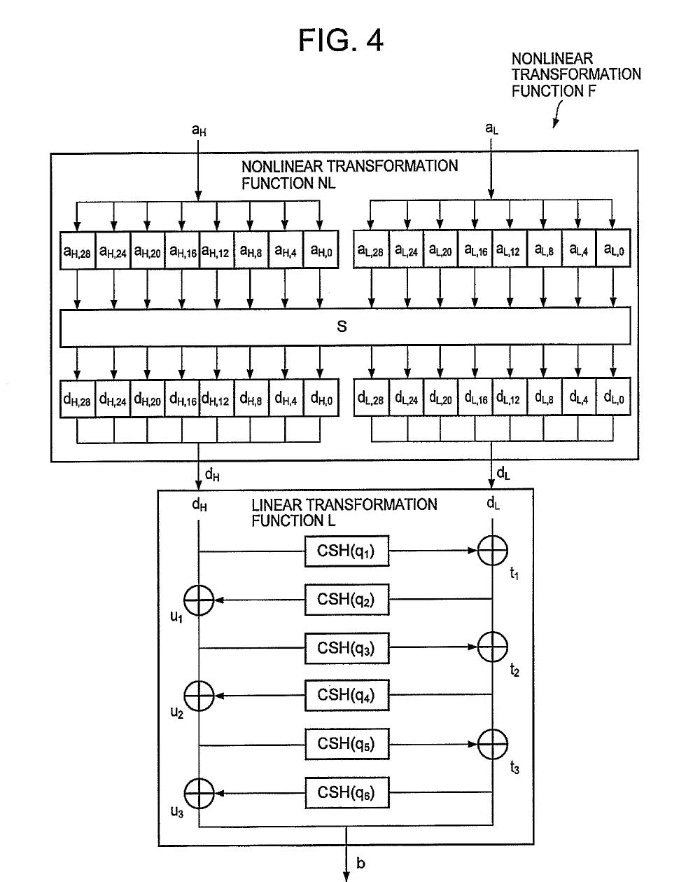

Next, the nonlinear transformation function F in FIGS. 2 and 3 will be described referring to FIG. 4.

FIG. 4 is a schematic diagram showing the nonlinear transformation function F.

As shown in the figure, the nonlinear transformation function F is a function that performs combined transformation of a nonlinear transformation function NL and a linear transformation function L. The nonlinear transformation function NL and the linear transformation function L are a transformation having two block inputs and two block outputs. The nonlinear transformation function F is defined as F=L(NL), i.e., a composite function of these transformation functions.

First, the nonlinear transformation function NL will be described.

Here, two input blocks to the nonlinear transformation function NL are written as a_{H} and a_{L}.

Each block inputted to the nonlinear transformation function NL is separated into parts of 4 bits. Each 4-bit part is subjected to a nonlinear transformation by using a substitution table S that specifies a value corresponding to each 4-bit part (a_{H,i+16}∥a_{H,i}∥a_{L,i+16}∥a_{L,i}←S[a_{H,i+16}∥a_{H,i}∥a_{L,i+16}∥a_{L,i}], 0≦i<16). Here, a_{H,i} (a_{H,i}) expresses the i-th bit from the least significant bit of a_{H} (a_{L}), and the symbol S[x] expresses reference to the substitution table S.

Here, the substitution table S is defined, for example, as S[256]={4, 14, 15, 1, 13, 9, 10, 0, 11, 2, 7, 12, 3, 6, 8, 5}.

Further, instead of such a substitution table S, a composite function of an inverse element operation and an affine transformation on a finite field may be used, for example.

Next, the linear transformation function L will be described.

Here, two input blocks to the linear transformation function L are written as d_{H} and d_{L}.

The linear transformation function L includes a cyclic shift function and exclusive-OR. As shown in the following, transformation is performed by applying the cyclic shift function six times, to update values of d_{H} and d_{L}. Here, the cyclic shift function CSH(q, x) expresses left cyclic shift of x by q bits in the block width.

First, the transformation part 123 performs a left cyclic shift of the value of the input block d_{H} by q₁ bits, and calculates an exclusive-OR of the shift result and the value of the input block d_{L} to obtain a value t₁ (t₁=d_{L} XOR CSH(q₁, d_{H})).

Next, the transformation part 123 performs a left cyclic shift of the value t₁ by q₂ bits, and calculates an exclusive-OR of the shift result and the value of the input block d_{H} to obtain a value u₁ (u₁=d_{H} XOR CSH(q₂, t₁)).

Next, the transformation part 123 performs a left cyclic shift of the value u₁ by q₃ bits, and calculates an exclusive-OR of the shift result and the value t₁ to obtain a value t₂ (t₂=t₁ XOR CSH(q₃, u₁)).

Next, the transformation part 123 performs a left cyclic shift of the value t₂ by q₄ bits, and calculates an exclusive-OR of the shift result and the value u₁, to obtain a value u₂ (u₂=u₁ XOR CSH(q₄, t₂)).

Next, the transformation part 123 performs a left cyclic shift of the value u₂ by q₅ bits, and calculates an exclusive-OR of the shift result and the value t₂, to obtain a value t₃ (t₃=t₂ XOR CSH (q₅, u₂)).

Next, the transformation part 123 performs a left cyclic shift of the value t₃ by q₆ bits, and calculates an exclusive-OR of the shift result and the value u₂, to obtain a value u₃ (u₃=u₂ XOR CSH(q₆, t₃)).

By concatenating the thus-obtained values u₃ and t₃, the transformation part 123 obtains an output value b.

Here, in the combination of the values q₁, q₂, q₃, q₄, q₅ and q₆ used for the left cyclic shifts, at least one value among these values is an odd number and at least one value is an even number.

Further, with respect to such a combination, it is desirable that, among differences between any pair of thirteen values q₁+q₂, q₁+q₄, q₃+q₄, q₁+q₂+q₃+q₄, q₁+q₆, q₃+q₆, q₁+q₂+q₃+q₆, q₅+q₆, q₁+q₂+q₅+q₆, q₁+q₄+q₅+q₆, q₁+q₃+q₄+q₅+q₆, q₂+q₃+q₄+q₅+q₆ and q₁+q₂+q₃+q₄+q₅+q₆, the number of pairs whose differences are multiples of 32 is three or less.

In the present embodiment, a combination (q₁, q₂, q₃, q₄, q₅, q₆)=(1, 3, 4, 7, 8, 14) is used, although there is no limitation to this example.

By selecting values of q₁, q₂, q₃, q₄, q₅ and q₆ as described above, it is possible to ensure security with a smaller amount of processing in comparison with conventional techniques. In other words, security can be ensured with a smaller number of shifts. Further, arithmetic addition is not employed in the composite processing, and thus there is less computational complexity and lightweight implementation can be realized.

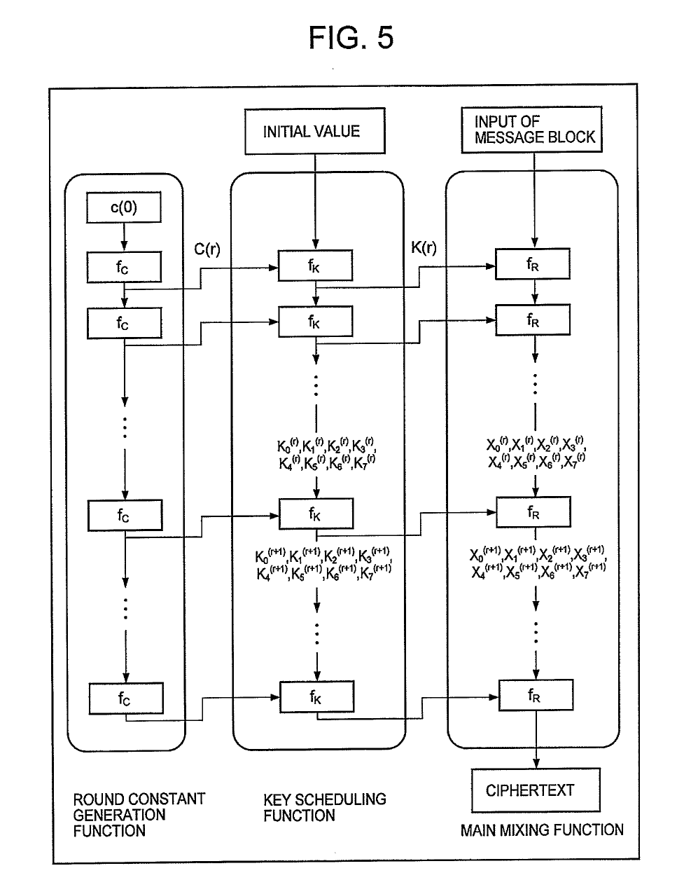

The above-described processing in the round constant generation part 122 and the transformation part 123 assumes the block cipher shown in FIG. 5 (a schematic diagram for explaining block cipher).

According to this block cipher, data processing is divided into three processing functions, referred to as, from the left of FIG. 5, a round constant generation function, a key scheduling function, and a main mixing function.

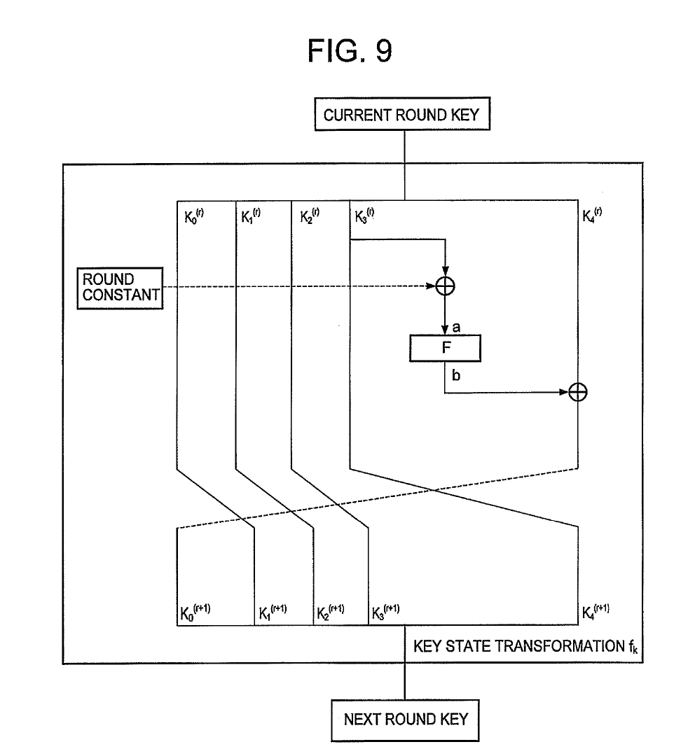

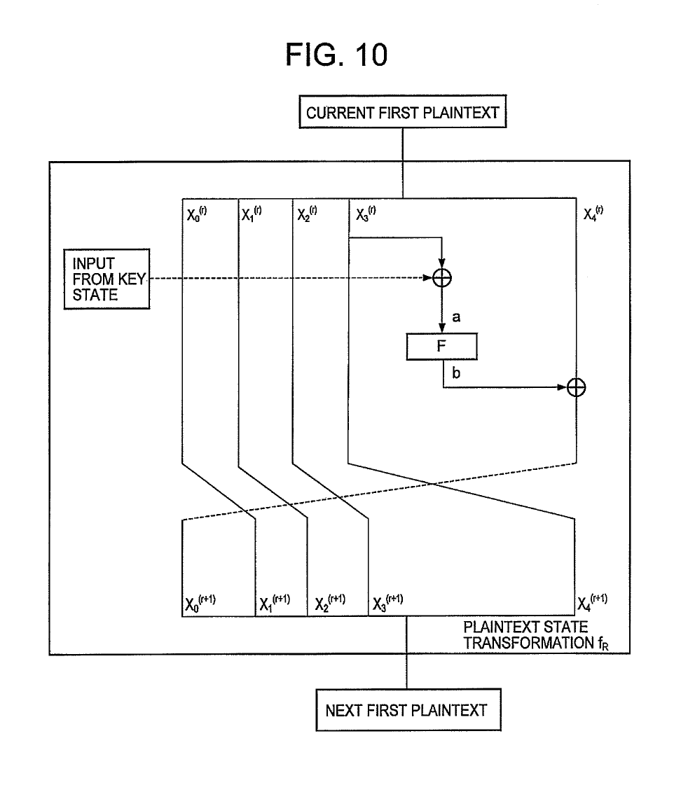

As seen from the figure, processing involves repeated operations of a single function (ROUND NUM times, in the present embodiment) on input for all cases. Unit processing functions in the three processing functions are referred to as a round constant generating function f_{c}, a round key generating function fₖ (which corresponds to the key state transformations in FIGS. 2 and 9), and a round function f_{R} (which corresponds to the plaintext transformations in FIGS. 3 and 10), respectively.

The round constant generation function inputs a round constant initial value c(0) to the round constant generating function f_{c} so as to generate a round constant C(r) serially for each process by the round constant generating function f_{c}.

By inputting thus-generated round constant C(r) as auxiliary input to the round key generating function fₖ and inputting an initial value of a round key to the round key generating function fₖ, the key scheduling function generates a round key K(r) serially for each process by the round key generating function fₖ.

Then, by inputting a round key K(r) generated by the key scheduling function as auxiliary input and inputting a message block, the main mixing function repeats the processing by the round function f_{R} a predetermined number of rounds, to output a cipher text.

Here, when the same function is used as both the round key generating function fₖ and the round function f_{R} in the present embodiment, it is possible to generate a hash function that ensures theoretical security and implementation security even for a device with a small-scale implementation.

The management part 124 calculates, with respect to a message block, an exclusive-OR of a first plaintext that is obtained by finishing the processing of changing a first plaintext of a predetermined round and a second plaintext of the n-th message block, to obtain a second plaintext of the (n+1)-th message block, and stores the obtained second plaintext of the (n+1)-th message block into the second plaintext state storage area 114, replacing the second plaintext of the n-th message block.

Further, when the processing of changing the first plaintext of the predetermined round has been finished with respect to all the message blocks and the second plaintext has been calculated and stored in the second plaintext state storage area 114, then the management part 124 performs processing of outputting, as a hash value, the second plaintext stored in the second plaintext state storage area 114 through the below-mentioned input/output part 130.

The general control part 125 controls the whole processing of generating a hash value in the hash value generation device 100.

In particular, in the present embodiment, the general control part 125 performs processing of resetting information stored in the key state storage area 112, the first plaintext state storage area 113 and the second plaintext state storage area 114, processing of counting the number of message blocks and the number of rounds, and processing of setting an initial value of a round key or a second plaintext in the key state storage area 112.

The input/output part 130 inputs and outputs data.

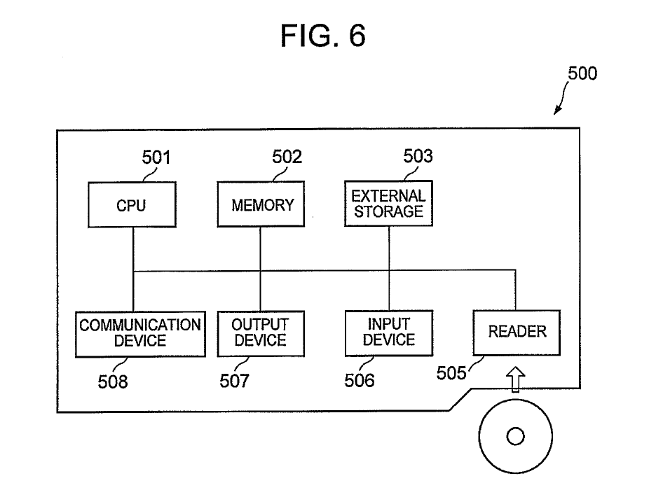

The above-described hash value generation device 100 can be realized, for example, by an ordinary computer 500 comprising a CPU 501, a memory 502, an external storage 503 such as an HDD, a reader 505 for reading information from a portable storage medium 504 such as a CD-ROM, a DVD-ROM or the like, an input device 506 such as a keyboard or a mouse, an output device 507 such as a display, and a communication device 508 such as a network interface card (NIC) for connecting to a communication network, as shown in FIG. 6 (a schematic diagram showing the computer 500).

For example, the storage part 110 can be realized when the CPU 501 uses the memory 502 or the external storage 503. The control part 120 can be realized when a predetermined program stored in the external storage 503 is loaded onto the memory 502 and executed by the CPU 501. The input/output part 130 can be realized when the CPU 501 uses the output device 507 and the input device 506.

The above-mentioned predetermined program may be downloaded from the storage medium 504 through the reader 505 or from the network through the communication device 508 to the external storage 503, and then loaded into the memory 502 and executed by the CPU 501, or the predetermined program may be directly downloaded from the storage medium 504 through the reader 505 or from the network through the communication device 508 into the memory 502, and executed by the CPU 501. The program may be referred to as code or as a module.

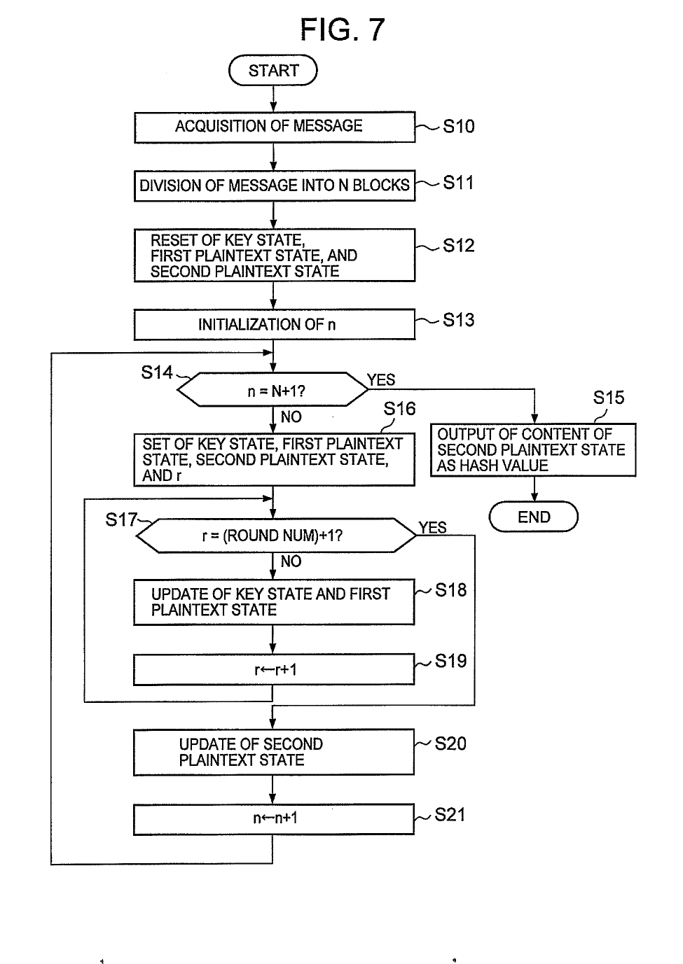

Hash value generation processing in the hash value generation device 100 of the above-described construction will be described referring to the flowchart shown in FIG. 7.

First, the hash value generation device 100 acquires, through the input/output part 130, a message that is a basis for generating a hash value (S10).

Next, the message blocking part 121 divides the message acquired through the input/output part 130, to generate N message blocks each of a predetermined data length (S11). In the present embodiment, the message is divided into message blocks of 256-bit data length.

Next, the general control part 125 resets information stored in the key state storage area 112, the first plaintext state storage area 113, and the second plaintext state storage area 114 (S12). Specifically, all bit values are set to “0”.

Next, the general control part 125 initializes a value n of a message counter, i.e., a counter for message blocks (S13). Here, the value n of the message counter is set to “1”.

Next, the general control part 125 judges whether the value n of the message counter equals N+1 (n=N+1), where N is the number of the blocks of the divided message (S14).

When n=N+1 in step S14, then the flow proceeds to step S15, in which a second plaintext stored in the second plaintext state storage area 114 is outputted as a hash value through the input/output part 130 (S15), and the processing is ended.

When n=N+1 is not satisfied in step S14, the flow proceeds to step S16.

In step S16, the general control part 125 stores (sets) respective pieces of predetermined data in the key state storage area 112, the first plaintext state storage area 113 and the second plaintext state storage area 114, and sets a round counter (i.e. a counter of rounds) r to an initial value.

Here, in the case of n=1, the general control part 125 stores the round key's initial value stored in the initial value storage area 111 into the key state storage area 112, and a message block Mn corresponding to the message counter n into the first and second plaintext state storage areas 113 and 114, and sets the round counter r to “1”.

On the other hand, in the case of n>1, the general control part 125 stores the second plaintext stored in the second plaintext state storage area 114 into the key state storage area 112, and the message block Mn corresponding to the message counter n into the first and second plaintext state storage areas 113 and 114, and sets the round counter r to “1”.

Next, the general control part 125 judges whether the value r of the round counter satisfies the relation r=(ROUND NUM)+1, where ROUND NUM is the predetermined number of rounds (S17). When the relation r=(ROUND NUM)+1 is satisfied in step S17, the flow proceeds to step S20. On the other hand, when the relation r=(ROUND NUM)+1 is not satisfied, the flow proceeds to step S18.

In step S18, the round constant generation part 122 and the transformation part 123 update the round key stored in the key state storage area 112 and the first plaintext stored in the first plaintext state storage area 113.

Specifically, the round constant generation part 122 calculates a round constant C(r) in the round corresponding to the round counter r.

Then, the transformation part 123 calculates the round key K^{(r)} in the round corresponding to the round counter r from the round key K^{(r-1)} in the round corresponding to the round counter (r−1), taking the round constant C(r) calculated by the round constant generation part 122 as auxiliary input. The round key K^{(r-1)} is stored in the key state storage area 112. Here, the transformation part 123 stores the thus-calculated round key K^{(r)} into the key state storage area 112, replacing the round key K^{(r-1)}.

Then, the transformation part 123 calculates a first plaintext X^{(r)} in the round corresponding to the round counter r from the first plaintext X^{(r-1)} in the round corresponding to the round counter (r−1), taking the round key K^{(r)} calculated by the round constant generation part 122 as auxiliary input. The first plaintext X^{(r-1)} is stored in the first plaintext state storage area 113. Here, the transformation part 123 stores the thus-calculated first plaintext X^{(r)} into the first plaintext state storage area 113, replacing the first plaintext X^{(r-1)}.

Next, the general control part 125 increments the value r of the round counter by “1”, and the flow returns to step S17 to repeat the processing.

Further, in step S20, the management part 124 calculates an exclusive-OR of the second plaintext stored in the second plaintext state storage area 114 and the first plaintext stored in the first plaintext state storage area 113, to obtain the calculation result as the next second plaintext, and stores the calculated next second plaintext into the second plaintext state storage area 114, replacing the already-stored second plaintext.

Then, the general control part 125 increments the value n of the message counter by “1” (S21), and the flow returns to step S14 to repeat the processing.

As described above, the present embodiment employs the 256-bit block cipher, and thus can provide the hash function that ensures theoretical security and implementation security. At the same time, in the present embodiment, the transformation part uses the same function as both the function for transforming a round key and the function for transforming a first plaintext, and thus, small-scale implementation can be realized.

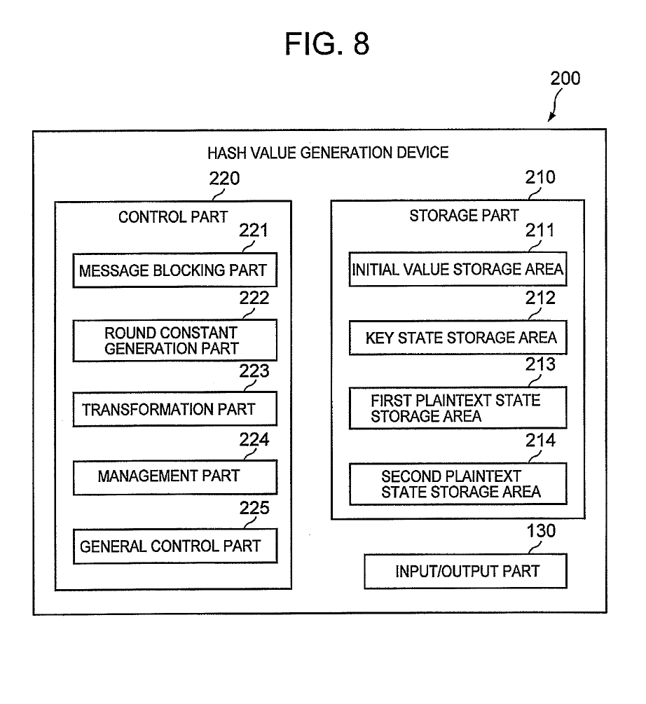

FIG. 8 is a schematic diagram showing a hash value generation device 200 of a second embodiment of the present invention.

In the first embodiment, a hash value generated by the hash value generation device 100 is 256 bits. In the present embodiment, a hash value of 160 bits is generated.

As shown in the figure, the hash value generation device 200 comprises a storage part 210, a control part 220, and an input/output part 130.

The storage part 210 comprises an initial value storage area 211, a key state storage area 212, a first plaintext state storage area 213 and a second plaintext state storage area 214.

Similarly to the first embodiment, the initial value storage area 211 stores an initial value of a round constant and an initial value of a round key as initial values in generating a hash value.

Here, as the initial value of a round constant, for example, a constant such as c(0)=0xcae1ac3f55054a96 is stored.

Further, as initial values for a round key, such constants as K₀⁽⁰⁾=0xbc18bf6d, K₁⁽⁰⁾=0x369c955b, K₂⁽⁰⁾=0xbb271cbc, K₃⁽⁰⁾=0xdd66c368 and K₄⁽⁰⁾=0x356dba5b are stored, for example.

Constants used as the initial values of the round constant and a round key are not limited to these. For example, it is possible to use random numbers generated by a pseudo-random number generator.

Similarly to the first embodiment, the key state storage area 212 stores information specifying a round key in each round for a message block. Differently, however, from the first embodiment, a round key of 160 bits is stored in the key state storage area 212 in the present embodiment.

Similarly to the first embodiment, the first plaintext state storage area 213 stores information specifying a first plaintext that is calculated for each round. In the present embodiment, however, a first plaintext of 160 bits is stored.

Similarly to the second embodiment, the second plaintext state storage area 214 stores information specifying a second plaintext that is calculated for each block. In the present embodiment, however, a second plaintext of 160 bits is stored.

The control part 220 comprises a message blocking part 221, a round constant generation part 222, a transformation part 223, a management part 224 and a general control part 225.

The message blocking part 221 performs processing of dividing a message inputted through the input/output part 130 into blocks of a predetermined data length.

In the present embodiment, the message blocking part 221 divides a message inputted through the below-mentioned input/output part 130 into message blocks of 160 bits each.

However, in the case where the length of a message is not a multiple of a message block (160 bits), a padding method such as the Merkle-Damgaard method is employed to pad the message such that the message becomes a multiple of a message block.

Similarly to the first embodiment, the round constant generation part 222 calculates a round constant in each round.

The transformation part 223 performs transformation of a round key and a first plaintext in each round for a message block. Here, transformation performed by the transformation part 223 does not include arithmetic addition.

First the transformation part 123 of the present embodiment performs transformation of a round key.

Transformation of a round key is performed, for example, by the key state transformation function fₖ shown in FIG. 9 (a schematic diagram showing the key state transformation function fₖ).

As shown in the figure, the key state transformation fₖ is a function that transforms five divisions K₀^{(r)}, K₁^{(r)}, K₂^{(r)}, K₃^{(r)} and K₄^{(r)} of a round key of the r-th round into K₀^{(r+1)}, K₁^{(r+1)}, K₂^{(r+1)}, K₃^{(r+1)} and K₄^{(r+1)} respectively, and then concatenates the transformed values, to generate a (r+1)-th round key.

In detail, with regard to the key state transformation fₖ, first the transformation part 223 divides the round key of the r-th round, which is stored in the key state storage area 212, into five parts K₀^{(r)}, K₁^{(r)}, K₂^{(r)}, K₃^{(r)} and K₄^{(r)} equally.

Next, the transformation part 223 inputs an exclusive-OR of the round constant C(r) generated by the round constant generation part 222 and K₃^{(r)} of the round key of the r-th round to the nonlinear transformation function F to calculate an output value b (b=F(k₃ XOR C(r))).

Next, the transformation part 223 calculates an exclusive-OR of the output value b and K₄ (r) of the round key of the r-th round, and takes the calculated value as K₀^{(r+1)} of the round key of the (r+1)-th round.

Next, the transformation part 223 takes K₃^{(r)}, K₂^{(r)}, K₁^{(r)} and K₀^{(r)} of the round key of the r-th round as K₄^{(r+1)}, K₃^{(r+1)}, K₂^{(r+1)} and K₁^{(r+1)} of the round key of the (r+1)-th round.

Then, the transformation part 223 concatenates thus-calculated K₀^{(r+1)}, K₁^{(r+1)}, K₂^{(r+1)}, K₃^{(r+1)} and K₄^{(r+1)}, and stores the concatenation result as the round key of the (r+1)-th round into the key state storage area 212, replacing the round key of the r-th round.

Further, the transformation part 223 of the present embodiment transforms a first plaintext.

Transformation of a first plaintext is performed, for example, by a plaintext state transformation function f_{R} shown in FIG. 10 (a schematic diagram showing the plaintext state transformation function f_{R}).

As shown in the figure, the plaintext transformation f_{R} is a function that transforms words X₀^{(r)}, X₁^{(r)}, X₂^{(r)}, X₃^{(r)} and X₄^{(r)} obtained as five divisions of a first plaintext of the r-th round into X₀^{(r+1)}, X₁^{(r+1)}, X₂^{(r+1)}, X₃^{(r+1)} and X₄^{(r+1)} respectively, and then concatenates the values of these transformed words, to generate a first plaintext of the (r+1)-th round.

As for the plaintext state transformation function f_{R}, first transformation part 123 divides the first plaintext of the r-th round into five words X₀^{(r)}, X₁^{(r)}, X₂^{(r)}, X₃^{(r)} and X₄^{(r)}. The first plaintext of the r-th round is stored in the first plaintext state storage area 213.

Next, the transformation part 223 inputs an exclusive-OR of the round key K(r) stored in the key state storage area 212 and the word X₃^{(r)} to the nonlinear transformation function F, to calculate an output value b (b=F(X₃ XOR K(r))).

Next, the transformation part 223 calculates an exclusive-OR of the output value b and the word X₄^{(r)}, and takes the calculated value as a word X₀^{(r+1)}.

Next, the transformation part 223 takes the words X₃^{(r)}, X₂^{(r)}, X₁^{(r)} and X₀^{(r)} as X₄^{(r+1)}, X₃^{(r+1)}, X₂^{(r+1)} and X₁^{(r+1)} respectively.

Then, the transformation part 223 concatenates thus-calculated X₀^{(r+1)}, X₁^{(r+1)}, X₂^{(r+1)}, X₃^{(r+1)} and X₄^{(r+1)}, and stores the concatenation result as a first plaintext of the (r+1)-th round into the first plaintext state storage area 213, replacing the first plaintext of the r-th round.

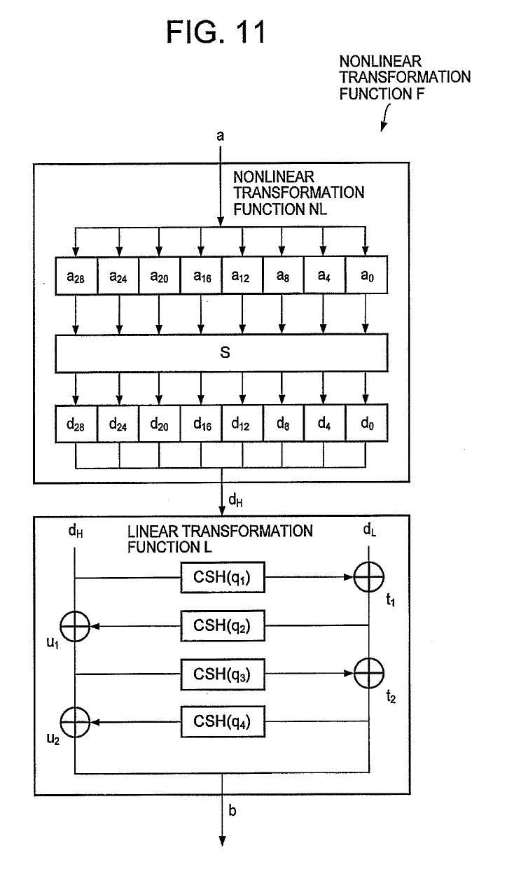

Next, the nonlinear transformation function F in FIGS. 9 and 10 will be described, referring to FIG. 11.

FIG. 11 is a schematic diagram showing the nonlinear transformation function F.

As shown in the figure, the nonlinear transformation function F is a function that performs composite function of a nonlinear transformation function NL and a linear transformation function L.

The nonlinear transformation function NL and the linear transformation function L in the present embodiment are transformations having one block input and one block output. The nonlinear transformation function F is defined as F=L(NL), i.e., composite function of these transformation functions.

First, the nonlinear transformation function NL will be described.

Here, an input block to the nonlinear transformation function NL is written as a.

Each block inputted to the nonlinear transformation function NL is separated into parts of 4 bits. Each 4-bit part is subjected to nonlinear transformation by using a substitution table S that specifies a value corresponding to each 4-bit part (dᵢ₊₂₄∥dᵢ₊₁₆∥dᵢ₊₈∥dᵢ←S[aᵢ₊₂₄∥aᵢ₊₁₆∥aᵢ₊₈∥aᵢ], 0≦i<8). Here, aᵢ expresses the i-th bit from the least significant bit of a, and the symbol S[x] expresses reference to the substitution table S.

Here, the substitution table S is defined, for example, as S[256]={4, 14, 15, 1, 13, 9, 10, 0, 11, 2, 7, 12, 3, 6, 8, 5}.

Further, instead of such a substitution table S, a composite function of an inverse element operation and an affine transformation on a finite field may be used, for example.

Next, the linear transformation function L will be described.

Here, the linear transformation function L divides an input block d into a block d_{H} of upper bits and a block d_{L} of lower bits, and performs processing as follows.

The linear transformation function L includes a cyclic shift function and exclusive-OR, and performs the following transformation to update values of d_{H} and d_{L}. Here, the cyclic shift function CSH(q, x) expresses a left cyclic shift of x by q bits in the block width.

First, the transformation part 223 performs a left cyclic shift of the value of the input block d_{H} by q₁ bits, and calculates an exclusive-OR of the shift result and the value of the input block d_{L} to obtain a value t₁ (t₁=d_{L} XOR CSH(q₁, d_{H})).

Next, the transformation part 223 performs a left cyclic shift of the value t₁ by q₂ bits, and calculates an exclusive-OR of the shift result and the value of the input block d_{H} to obtain a value u₁ (u₁=d_{H} XOR CSH(q₂, t₁)).

Next, the transformation part 223 performs a left cyclic shift of the value u₁ by q₃ bits, and calculates an exclusive-OR of the shift result and the value of t₁ to obtain a value t₂ (t₂=t₁ XOR CSH(q₃, u₁)).

Next, the transformation part 223 performs a left cyclic shift of the value t₂ by q₄ bits, and calculates an exclusive-OR of the shift result and the value u₁ to obtain a value u₂ (u₂=u₁ XOR CSH (q₄, t₂)).

By concatenating the thus-obtained values u₂ and t₂, the transformation part 223 calculates an output value b (=u₂∥t₂).

Here, in the combination of the values q₁, q₂, q₃ and q₄ used for the left cyclic shifts, at least one value among these values is an odd number and at least one value is an even number.

In the present embodiment, a combination (q₁, q₂, q₃, q₄)=(1, 3, 4, 7) is used, although there is no limitation implied by this example.

The above-described processing in the round constant generation part 222 and the transformation part 223 assumes the block cipher shown in FIG. 5 (a schematic diagram for explaining block cipher) similarly to the first embodiment.

Here, in the present embodiment, when the same function is used as both the round key generating function f_{K} and the round function f_{R}, it is possible to generate a hash function that ensures theoretical security and implementation security even for a small-scale implementation device.

The management part 124 calculates an exclusive-OR of a first plaintext that is obtained by finishing the processing of changing a first plaintext in all the predetermined rounds and a second plaintext of the n-th message block, to obtain a second plaintext of the (n+1)-th message block, and stores the obtained second plaintext of the (n+1)-th message block into the second plaintext state storage area 214, replacing the second plaintext of the n-th message block.

Further, when the processing of changing the first plaintexts of all the predetermined rounds has been finished with respect to all the message blocks, and the second plaintext has been calculated and stored in the second plaintext state storage area 214, then the management part 224 performs processing of outputting, as a hash value, the second plaintext stored in the second plaintext state storage area 214 through the below-mentioned input/output part 130.

The general control part 225 controls the whole processing of generating a hash value in the hash value generation device 200.

In particular, in the present embodiment, the general control part 225 performs processing of resetting information stored in the key state storage area 212, the first plaintext state storage area 213 and the second plaintext state storage area 214, and processing of counting the number of message blocks and the number of rounds.

The input/output part 130 inputs and outputs data.

The above-described hash value generation device 200 can be realized, for example, by the computer 500 shown in FIG. 6.

Hash value generation processing in the hash value generation device 200 of the above-described construction is similar to the processing of the flowchart shown in FIG. 7, and its description is omitted.

As described above, the present embodiment employs the 160-bit block cipher, and thus can provide the hash function that ensures theoretical security and implementation security. At the same time, in the present embodiment, the transformation part uses the same function as both the function for transforming a round key and the function for transforming a first plaintext, and thus, small-scale implementation can be realized.

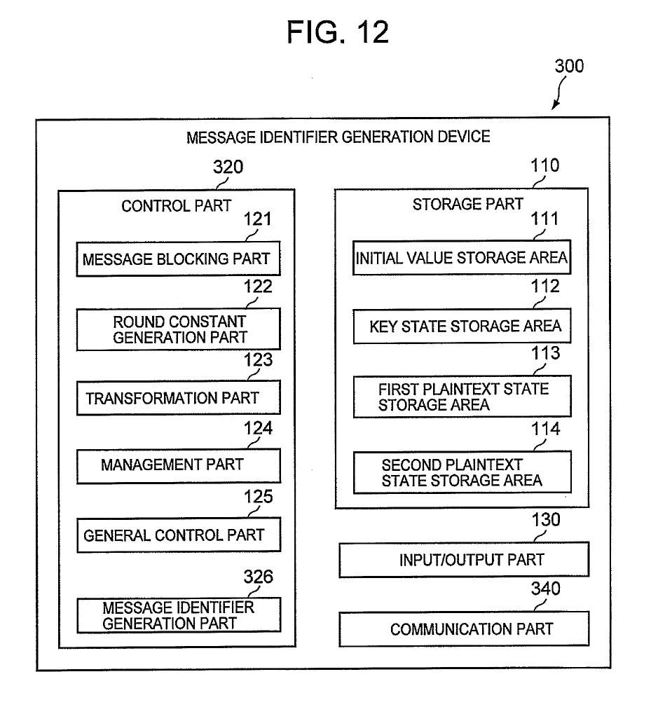

FIG. 12 is a schematic diagram showing a message identifier generation device 300 as a third embodiment of the present invention.

In the “ubiquitous” society, it is expected that a high speed and lightweight cryptographic technology is applied to a field requiring high speed processing in a server with clients being limited in their resources mounted. In the following, a data authentication and delivery system that uses the first embodiment will be described. In the present embodiment, as an authentication technique, an HMAC, i.e., a MAC generation method based on a hash function is employed.

As shown in the figure, the message identifier generation device 300 comprises a storage part 110, a control part 320, an input/output part 130, and a communication part 340. The storage part 110 and the input/output part 130 are the same as in the first embodiment, and their description is omitted.

The control part 320 of the present embodiment comprises a message blocking part 121, a round constant generation part 122, a transformation part 123, a management part 124, a general control part 125 and a message identifier generation part 326. In comparison with the first embodiment, the message identifier generation part 326 is added, and matters concerning this point will be described in the following.

The message identifier generation part 326 generates a message identifier by using a hash value that is generated by the message blocking part 121, the round constant generation part 122, the transformation part 123, the management part 124 and the general control part 125.

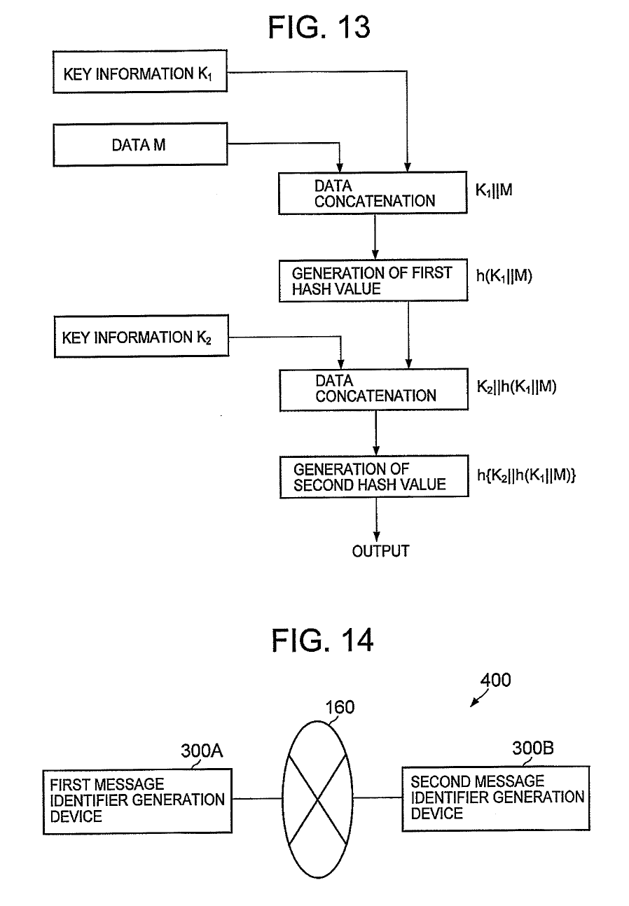

In detail, the message identifier generation part 326 concatenates data M inputted through the input/output part 130 and predetermined key information K₁, to generate a message K₁∥M as shown in FIG. 13 (a schematic diagram showing a procedure for generating a message identifier).

Next, the message identifier generation part 326 generates a first hash value h(K₁∥M), i.e., a hash value of the message K₁∥M, by using the message blocking part 121, the round constant generation part 122, the transformation part 123, the management part 124, and the general control part 125.

Next, the message identifier generation part 326 concatenates the first hash value h(K₁∥M) and key information K₂, to generate a message K₂∥(K₁∥M).

Then, the message identifier generation part 326 generates a second hash value h(K₂∥h(K₁∥M)), i.e., a hash value of the message K₂∥(K₁∥M), by using the message blocking part 121, the round constant generation part 122, the transformation part 123, the management part 124, and the general control part 125.

Then, the message identifier generation part 326 outputs the second hash value as a message identifier of the data M through the input/output part 130 or the communication part 340.

The message identifier generation device 300 can be realized, for example, by an ordinary computer 500 comprising a CPU 501, a memory 502, an external storage 503 such as an HDD, a reader 505 for reading information from a portable storage medium 504 such as a CD-ROM, a DVD-ROM or the like, an input device 506 such as a keyboard or a mouse, an output device 507 such as a display, and a communication device 508 such as an NIC for connecting to a communication network.

For example, the storage part 110 can be realized when the CPU 501 uses the memory 502 or the external storage 503. The control part 320 can be realized when a predetermined program stored in the external storage 503 is loaded into the memory 502 and executed by the CPU 501. The input/output part 130 can be realized when the CPU 501 uses the output device 507 and the input device 506. The communication part 340 can be realized when the CPU 501 uses the communication device 508.

The above-mentioned predetermined program may be downloaded from the storage medium 504 through the reader 505 or from the network through the communication device 508 to the external storage 503, and then loaded into the memory 502 and executed by the CPU 501, or the predetermined program may be directly downloaded from the storage medium 504 through the reader 505 or from the network through the communication device 508 into the memory 502, and executed by the CPU 501.

The message identifier generation device 300 of the above-described construction can be used, for example, by connecting a first message identifier generation device 300A and a second message identifier generation device 300B through a network 160 as shown in FIG. 14 (a schematic diagram showing a delivery system 400).

In such a delivery system, data are sent and received as described in the following.

Here, it is assumed that the first message identifier generation device 300A and the second message identifier generation device 300B share, in advance, the key information K₁ and K₂, in a secret state.

First, the first message identifier generation device 300A generates a first message identifier V of 256 bits with respect to data M, by means of the message identifier generation part 326 using the key information K₁ and K₂ as described above.

Then, the first message identifier generation device 300A sends a concatenation (L=M∥V) of the first message identifier V and the data M to the second message identifier generation device 300B by means of the communication part 340 and through the network 160.

The second message identifier generation device 300B receives the data L′=M′∥V′ through the communication part 340 and extracts a second message identifier V′ of 256 bits from the data, to obtain second data M′.

Then, the second message identifier generation device 300B generates a third message identifier V″ by means of the message identifier generation part 326 on the basis of the second data M′ and the key information K₁ and K₂ as described above.

The general control part 125 of the second message identifier generation device 300B judges that the second data M′ have been altered, when the third message identifier V″ is not equal to the second message identifier V′.

On the other hand, when these message identifiers are equal, the second message identifier generation device 300B takes the received second data M′ as authenticated data.

As described above, the message identifier generation device 300 of the present embodiment can be used for a system in which sent and received data are authenticated.

Further, in the third embodiment, a message identifier is generated by using a hash value described in the first embodiment. However, without being limited to this mode, it is possible to generate a message identifier by using a hash value described in the second embodiment.

Further, in the embodiments described above, the same function is used both as the key state transformation fₖ and as the plaintext state transformation f_{R}. However, in the case of a device of large-scale implementation, different functions may be used as these functions. In such a case, any shift operation, any linear or nonlinear function may be added to at least one of the key state transformation fₖ or the plaintext state transformation f_{R} described in these embodiments, to obtain a hash value of enhanced security.

Further, in the above-described embodiments, the hash value generation devices 100 and 200 can be realized by a computer as shown in FIG. 6. There is no limitation to these examples, and the hash value generation device can be realized in a small-scale implementation device comprising a CPU, a volatile or nonvolatile memory and a communication device, such as a portable telephone terminal, a non-contact IC card, a commodity tag or the like.

That is, the storage part 110 or 210 can be realized by a memory, and the control part 120 or 220 by a CPU. The input/output part 130 can be realized when a communication device receives or sends input/output data from or to an external device.

The above-described hash value generation devices 100 and 200 are not limited to those realized when a computer executes a program. For example, an integrated logic IC such as an Application Specific Integrated Circuit (ASIC) or a Field Programmable Gate Array (FPGA) may be used to realize the hash value generation devices by hardware, or a computer such as a Digital Signal Processor (DSP) may be used to realize the hash value generation devices by software.

The specification and drawings are, accordingly, to be regarded in an illustrative rather than a restrictive sense. It will, however, be evident that various modifications and changes may be made thereto without departing from the spirit and scope of the invention as set forth in the claims.

We claim:

1. A hash value generation device having a control part that divides an inputted message into N message blocks of a predetermined data length (N being a natural number), repeats transformation processing a predetermined number R of rounds (R being a natural number larger than or equal to 2) for each of the message blocks, and repeats, N times, block cipher processing in which a value calculated in the transformation processing of R rounds for an n-th message block (n being a natural number) is used as key information for an (n+1)-th message block, to generate a hash value of the message, wherein:
the transformation processing performed by the control part includes shift operation;
the shift operation repeats, a predetermined number of times, processing in which one of two pieces of inputted data is subjected to a cyclic shift by a predetermined number of bits, and the shifted piece of data is synthesized with another piece of data; and
among the cyclic shifts that are performed the predetermined number of times, at least one shift is a shift of an odd number of bits, and at least one shift is a shift of an even number of bits.

2. A hash value generation device of claim 1, wherein:
the predetermined number of times of the shift operations is six;
numbers of bits by which shifts are performed in the six shift operations are q₁, q₂, q₃, q₄, q₅ and q₆ in turn; and
q₁, q₂, q₃, q₄, q₅ and q₆ are determined such that, among differences between any pair of thirteen values q₁+q₂, q₁+q₄, q₃+q₄, q₁+q₂+q₃+q₄, q₁+q₆, q₃+q₆, q₁+q₂+q₃+q₆, q₅+q₆, q₁+q₂+q₅+q₆, q₁+q₄+q₅+q₆, q₁+q₃+q₄+q₅+q₆, q₂+q₃+q₄+q₅+q₆ and q₁+q₂+q₃+q₄+q₅+q₆, a number of pairs whose differences are multiples of 32 is three or less.

3. A hash value generation device of claim 1, wherein:
the transformation processing performed by the control part includes composite transformation; and
the composite transformation calculates an exclusive-OR.

4. A hash value generation device of claim 3, wherein:
the composite transformation does not include arithmetic addition.

5. A hash value generation device of claim 1, wherein:
the hash value generation device further comprises a storage part that stores an initial value of a round constant and an initial value of a round key; and
the control part performs, as the transformation processing:
processing in which a round constant for each round is calculated by a predetermined function from the round constant's initial value stored in the storage part;
processing in which a round key for each round is calculated by inputting, to a predetermined key transformation function, the round constant corresponding to the round in question and the round key calculated in a previous round from an initial value of the round key stored in the storage part; and
processing in which a first plaintext for each round is calculated by inputting the round key corresponding to the round in question and a first plaintext calculated from the message block in a previous round, to a predetermined plaintext transformation function.

6. A hash value generation device of claim 5, wherein:
a same function is used as both the key transformation function and the plaintext transformation function.

7. A hash value generation device of claim 6, wherein:
each of the key transformation function and the plaintext transformation function:
divides inputted data into Y₀^{(r)}, Y₁^{(r)}, Y₂^{(r)}, Y₃^{(r)}, Y₄^{(r)}, Y₅^{(r)}, Y₆^{(r)} and Y₇^{(r)}, and transforms values of Y₀^{(r)}, Y₁^{(r)}, Y₂^{(r)}, Y₃^{(r)}, Y₄^{(r)} and Y₅^{(r)} into Y₂^{(r+1)}, Y₃^{(r+1)}, Y₄^{(r+1)}, Y₅^{(r+1)}, Y₆^{(r+1)} and Y₇^{(r+1)};
inputs an exclusive-OR of Y₄^{(r)} and a predetermined constant, and Y₅^{(r)} to a predetermined nonlinear function to obtain a calculated value, and transforms an exclusive-OR of upper bits of the calculated value and Y₆^{(r)} to Y₀^{(r+1)};
transforms an exclusive-OR of lower bits of the calculated value and Y₇^{(r)}, to Y₁^{(r+1)}; and
concatenates the transformed Y₀^{(r+1)}, Y₁^{(r+1)}, Y₂^{(r+1)}, Y₃^{(r+1)}, Y₄^{(r+1)}, Y₅^{(r+1)}, Y₆^{(r+1)} and Y₇^{(r+1)} to obtain output data.

8. A hash value generation device of claim 6, wherein:
each of the key transformation function and the plaintext transformation function:
divides inputted data into Y₀^{(r)}, Y₁^{(r)}, Y₂^{(r)}, Y₃^{(r)} and Y₄^{(r)}, and transforms values of Y₀^{(r)}, Y₁^{(r)}, Y₂^{(r)} and Y₃^{(r)} into Y₁^{(r+1)}, Y₂^{(r+1)}, Y₃^{(r+1)} and Y₄^{(r+1)}, respectively;
inputs an exclusive-OR of Y₃^{(r)} and a predetermined constant to a predetermined nonlinear function to obtain a calculated value, and transforms an exclusive-OR of the calculated value and Y₄^{(r)} to Y₀^{(r+1)};
transforms an exclusive-OR of lower bits of the calculated value and Y₄^{(r)} to Y₁^{(r+1)}; and
concatenates the transformed Y₀^{(r+1)}, Y₁^{(r+1)}, Y₂^{(r+1)}, Y₃^{(r+1)} and Y₄^{(r+1)} to obtain output data.

9. A program product that makes a computer perform processing in which an inputted message is divided into N message blocks of a predetermined data length (N being a natural number), transformation processing is repeated a predetermined number R of rounds for each of the message blocks (R being a natural number larger than or equal to 2), and block cipher processing, in which a value calculated in the transformation processing of R rounds for an n-th message block is used as key information for an (n+1)-th message block (n being a natural number), is repeated N times, to generate a hash value of the message, wherein:
the program product comprises:
a computer-usable medium that supports computer-executable code that makes the computer carry out the method; and
code for shift operation in the transformation processing;
the code for shift operation comprises:
code that repeats, a predetermined number of times, processing in which one of two pieces of inputted data is subjected to a cyclic shift by a predetermined number of bits, and the shifted piece of data is synthesized with another piece of data; and code that performs a cyclic shift by an odd number of bits at least once among a predetermined number of cyclic shifts, and a cyclic shift by an even number of bits at least once among the predetermined number of cyclic shifts.

10. A program product of claim 9, wherein:
the predetermined number is six;
numbers of bits by which shifts are performed in the six shift operation are q₁, q₂, q₃, q₄, q₅ and q₆; and
among differences between any pair of thirteen values q₁+q₂, q₁+q₄, q₃+q₄, q₁+q₂+q₃+q₄, q₁+q₆, q₃+q₆, q₁+q₂+q₃+q₆, q₅+q₆, q₁+q₂+q₅+q₆, q₁+q₄+q₅+q₆, q₁+q₃+q₄+q₅+q₆, q₂+q₃+q₄+q₅+q₆ and q₁+q₂+q₃+q₄+q₅+q₆, a number of pairs whose differences are multiples of 32 is three or less.

11. A program product of claim 9, wherein the program product further comprises:
code that performs composite transformation in the transformation processing; and
code that calculates an exclusive-OR in the composite transformation.

12. A program product of claim 11, wherein:
the composite transformation does not include code that performs arithmetic addition.

13. A program product of claim 9, further comprising:
code that makes the computer function as a storage part for storing an initial value of a round constant and an initial value of a round key;
code for executing processing in which a round constant for each round is calculated from the round constant's initial value stored in the storage part, by a predetermined function, in the transformation processing;
code for executing processing in which a round key for each round is calculated by inputting, to a predetermined key transformation function, the round constant corresponding to the round in question and a round key calculated in a previous round from the round key's initial value stored in the storage part in the transformation processing; and
code for executing processing in which a first plaintext for each round is calculated by inputting the round key corresponding to the round in question and a first plaintext calculated in a previous round from the message block, to a predetermined plaintext transformation function, in the transformation processing.

14. A program product of claim 13, wherein:
the codes make the computer execute a same function as both the key transformation function and the plaintext transformation function.

15. A program product of claim 14, wherein the codes that make the computer execute the key transformation function and the plaintext transformation function include:
code that divides inputted data into Y₀^{(r)}, Y₁^{(r)}, Y₂^{(r)}, Y₃^{(r)}, Y₄^{(r)}, Y₅^{(r)}, Y₆^{(r)} and Y₇^{(r)};
code that transforms values of Y₀^{(r)}, Y₁^{(r)}, Y₂^{(r)}, Y₃^{(r)}, Y₄^{(r)} and Y₅^{(r)} into Y₂^{(r+1)}, Y₃^{(r+1)}, Y₄^{(r+1)}, Y₅^{(r+1)}, Y₆^{(r+1)} and Y₇^{(r+1)};
code that inputs an exclusive-OR of Y₄^{(r)} and a predetermined constant, and Y₅^{(r)} to a predetermined nonlinear function to obtain a calculated value, and transforms an exclusive-OR of upper bits of the calculated value and Y₆^{(r)}, to Y₀^{(r+1)};
code that transforms an exclusive-OR of lower bits of the calculated value and Y₇^{(r)}, to Y₁^{(r+1)}; and
code that concatenates the transformed Y₀^{(r+1)}, Y₁^{(r+1)}, Y₂^{(r+1)}, Y₃^{(r+1)}, Y₄^{(r+1)}, Y₅^{(r+1)}, Y₆^{(r+1)} and Y₇^{(r+1)} to obtain output data.

16. A program product of claim 14, wherein the codes that make the computer execute the key transformation function and the plaintext transformation function include:
code that divides inputted data into Y₀^{(r)}, Y₁^{(r)}, Y₂^{(r)}, Y₃^{(r)} and Y₄^{(r)};
code that transforms values of Y₀^{(r)}, Y₁^{(r)}, Y₂^{(r)} and Y₃^{(r)} into Y₁^{(r+1)}, Y₂^{(r+1)}, Y₃^{(r+1)} and Y₄^{(r+1)}, respectively;
code that inputs an exclusive-OR of Y₃^{(r)} and a predetermined constant to a predetermined nonlinear function to obtain a calculated value, and transforms an exclusive-OR of the calculated value and Y₄^{(r)}, to Y₀^{(r+1)};
code that transforms an exclusive-OR of lower bits of the calculated value and Y₄^{(r)}, to Y₁^{(r+1)}; and
code that concatenates the transformed Y₀^{(r+1)}, Y₁^{(r+1)}, Y₂^{(r+1)}, Y₃^{(r+1)} and Y₄^{(r+1)} to obtain output data.

17. A hash value generation method in which an inputted message is divided into N message blocks of a predetermined data length (N being a natural number), transformation processing is repeated a predetermined number R of rounds for each of the message blocks (R being a natural number larger than or equal to 2), and block cipher processing, in which a value calculated in the transformation processing of R rounds for an n-th) message block (n being a natural number is used as key information for an (n+1)-th message block, is repeated N times, to generate a hash value of the message, wherein:
the transformation processing performed by the control part includes a step of performing shift operation;
the step of performing shift operation repeats, a predetermined number of times, processing in which one of two pieces of inputted data is subjected to a cyclic shift by a predetermined number of bits, and the shifted piece of data is synthesized with another piece of data; and
among the cyclic shifts that are performed the predetermined number of times, at least one shift is a shift of an odd number of bits, and at least one shift is a shift of an even number of bits.
